(19) United States
(12) Patent Application Publication
(10) Pub. No.: US 2015/0148174 A1
(43) Pub. Date: May 28, 2015

(54) ELECTRIC VEHICLE TRANSAXLE

(71) Applicants: Koichi Nakamura, Miyoshi-shi (JP); Koichi Tanaka, Okazaki-shi (JP)

(72) Inventors: Koichi Nakamura, Miyoshi-shi (JP); Koichi Tanaka, Okazaki-shi (JP)

(73) Assignee: TOYOTA JIDOSHA KABUSHIKI KAISHA, Toyota-shi (JP)

(21) Appl. No.: 14/534,470

(22) Filed: Nov. 6, 2014

(30) Foreign Application Priority Data
Nov. 27, 2013 (JP) 2013-245409

(51) Int. Cl. F16D 41/07; F16H 1/28; F16H 57/04; B60K 17/04

(52) U.S. Cl. CPC F16D 41/07; B60K 17/04; F16H 1/28; F16H 57/0467; F16D 2041/0601
USPC 475/149; 192/41 R

(57) ABSTRACT

Providing an electric vehicle transaxle suppressing occurrence of wear, seizure, etc. of a one-way clutch as compared to a conventional one. When an electric motor MG is driven and a one-way clutch 34 moves in a rotation axis C1 direction, the one-way clutch 34 comes into contact with a flange portion 46b of an inner race 46 or a supporting portion 30b of a transaxle housing 30 via a sliding washer 74 and, therefore, direct contact is prevented between the one-way clutch 34 and the flange portion 46b of the inner race 46 or the supporting portion 30b and wear, seizure, etc. of the one-way clutch 34 are suppressed.

### CROSS-REFERENCE TO RELATED APPLICATION

This patent application is based upon and claims priority from Japanese Patent Application No. 2013-245409, filed on Nov. 27, 2013, incorporated herein by reference.

### FIELD OF THE INVENTION

The present invention relates to an electric vehicle transaxle housing a driving electric motor and an oil pump coupled via a one-way clutch to a power transmission member transmitting power of the driving electric motor and particularly to a technique of improving reliability or durability of the one-way clutch disposed in the electric vehicle transaxle.

### BACKGROUND OF THE INVENTION

An electric vehicle transaxle is known that houses, for example, a driving electric motor and an oil pump coupled via a one-way clutch to a power transmission member transmitting power of the driving electric motor. This corresponds to an electric vehicle transaxle as described in Japanese Laid-Open Patent Publication No. 2010-270789, for example.

### SUMMARY OF THE INVENTION

### Problem to Be Solved by the Invention

In the electric vehicle transaxle as described above, a gear disposed in the power transmission member is meshed with outer circumferential teeth formed on an outer race of the one-way clutch and, therefore, for example, the outer race may receive a load of the one-way clutch in a rotation axis direction due to high-speed rotary drive of the driving electric motor. Thus, the outer race, i.e., the one-way clutch may come into direct sliding contact with another component adjacent thereto, which may lead to deterioration in durability of the one-way clutch due to wear, seizure, etc.

The present invention was conceived in view of the situations and it is therefore an object of the present invention to provide an electric vehicle transaxle suppressing occurrence of wear, seizure, etc. of a one-way clutch as compared to a conventional one.

### Means for Solving the Problem

To achieve the object, the present invention provides (a) an electric vehicle transaxle housing a driving electric motor and an oil pump coupled via a one-way clutch to a power transmission member transmitting a power of the driving electric motor, (b) the one-way clutch being interposed between an inner race coupled to the oil pump and an outer race coupled to the power transmission member, the one-way clutch being held in a rotation axis direction between a flange portion disposed on an outer circumferential surface of the inner race and a supporting member rotatably supporting the inner race, (c) the electric vehicle transaxle being disposed with respective sliding washers having oil grooves between the one-way clutch and the flange portion and between the one-way clutch and the supporting member.

### Effects of the Invention

According to the electric vehicle transaxle configured as described above, when the driving electric motor is driven and the one-way clutch moves in the rotation axis direction of the one-way clutch, the one-way clutch comes into contact with the flange portion of the inner race or the supporting member via the sliding washer and, therefore, direct contact is prevented between the one-way clutch and the flange portion of the inner race or the supporting member and wear, seizure, etc. of the one-way clutch are suppressed.

Preferably, (a) the power transmission member is a ring gear of a planetary gear type speed reducer disposed concentrically to the driving electric motor for reducing rotation speed of the driving electric motor, (b) the outer race is engaged with inner circumferential teeth of the ring gear and is disposed rotatably along with the ring gear around the same rotation axis as the driving electric motor, and (c) the inner race is located on an inner circumferential side of the outer race and coupled to the oil pump and is disposed rotatably along with the oil pump around the same rotation axis as the driving electric motor. Therefore, the rotation of the driving electric motor is reduced via the planetary gear type speed reducer and transmitted to the one-way clutch.

Preferably, the oil pump is located on a side of the driving electric motor opposite to the one-way clutch and is coupled to the inner race via an oil pump shaft disposed relatively rotatably through a rotor of the driving electric motor. Therefore, the power transmission member and the oil pump can preferably be coupled via the one-way clutch.

Preferably, since a height of the flange portion from the outer circumferential surface of the inner race is equal to or greater than a height of the sliding washer, the uneven wear of the sliding washer can be prevented.

Preferably, the inner race is disposed with oil holes allowing lubrication oil discharged from the oil pump to flow out into the one-way clutch. Therefore, the lubrication oil flowing out from the oil holes of the inner race can lubricate components such as the one-way clutch via the oil grooves of the sliding washers. As a result, lubrication performance of the one-way clutch is preferably improved as compared to a conventional transaxle sending lubrication oil scraped up by a rotating member in the transaxle for lubricating the components such as the one-way clutch, for example.

Preferably, the electric vehicle transaxle is common with a main configuration of a transaxle of a conventional two-motor type hybrid vehicle and, therefore, component costs are reduced.

### BRIEF DESCRIPTION OF THE DRAWINGS

FIG. 1 is a schematic for explaining a configuration of an electric vehicle transaxle to which the present invention is preferably applied.

FIG. 2 is a cross section for explaining a configuration of the electric vehicle transaxle of FIG. 1.

FIG. 3 is an enlarged cross-sectional view of a periphery of a one-way clutch, an inner race, an outer race, etc., in the electric vehicle transaxle of FIG. 2.

FIG. 4 is a partly enlarged cross section of FIG. 3 for explaining a configuration of the one-way clutch of FIG. 3.

FIG. 5 is a cross section taken along V-V of FIG. 4.

FIG. 6 is a view taken along VI-VI of FIG. 4 for explaining a sliding washer disposed on each of the both side surfaces of the one-way clutch of FIG. 4. FIG. 7 is a cross section taken along VII-VII of FIG. 6.

FIG. 8 is a diagram depicting an electric vehicle transaxle of another embodiment of the present invention and corresponds to FIG. 5.

### MODES FOR CARRYING OUT THE INVENTION

An embodiment of the present invention will now be described in detail with reference to the drawings. In the following embodiment, the figures are simplified or deformed as needed and portions are not necessarily precisely depicted in terms of dimension ratio, shape, etc.

### First Embodiment

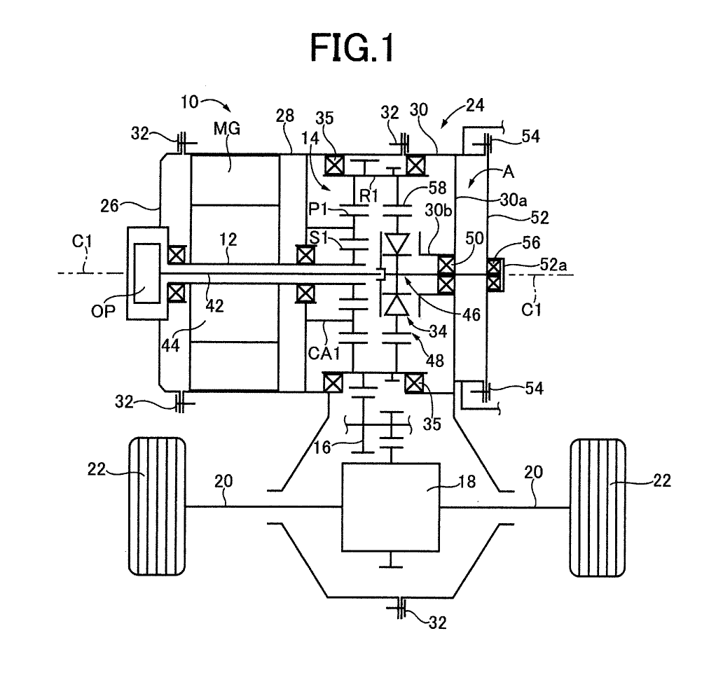

FIG. 1 is a schematic for explaining a configuration of a transaxle (electric vehicle transaxle) 10 to which the present invention is applied. The transaxle 10 is preferably applied to an electric vehicle using only an electric motor (driving electric motor) MG as a power source for running, for example. In the transaxle 10, a drive force output from an output shaft 12 of the electric motor MG is transmitted via well-known reduction planetary gears, i.e., a planetary gear type speed reducer 14 and a reduction gear device 16 to a differential gear device 18 to drive a pair of left and right drive wheels 22 via axles 20. The planetary gear type speed reducer 14 is a single pinion type planetary gear mechanism including a sun gear S1, a ring gear (power transmission member) R1 disposed on a concentric circle of the sun gear S1, and a carrier CA1 rotatably and revolvably supporting a pinion gear P1 meshed with the sun gear S1 and the ring gear R1, as three rotating elements, so as to generate a known differential action. The carrier CA1 is fixed to a transaxle case 28 described later, and the planetary gear type speed reducer 14 is configured such that rotation speed of the electric motor MG, i.e., rotation speed of the sun gear S1, is reduced and transmitted to the ring gear RE The planetary gear type speed reducer 14 is disposed concentrically to the electric motor MG.

As depicted in FIG. 1, the transaxle 10 includes a transaxle case member 24 housing the electric motor MG and gear devices such as the planetary gear type speed reducer 14, the reduction gear device 16, and the differential gear device 18. The transaxle case member 24 is made up of a transaxle rear cover 26 and the transaxle case 28 rotatably housing the electric motor MG, as well as a transaxle housing 30 rotatably housing the gear devices such as the planetary gear type speed reducer 14, the reduction gear device 16, and the differential gear device 18 along with the transaxle case 28. As depicted in FIG. 1, the transaxle rear cover 26, the transaxle case 28, and the transaxle housing 30 are integrally fixed by, for example, fixing members 32 such as bolts, in the transaxle case member 24.

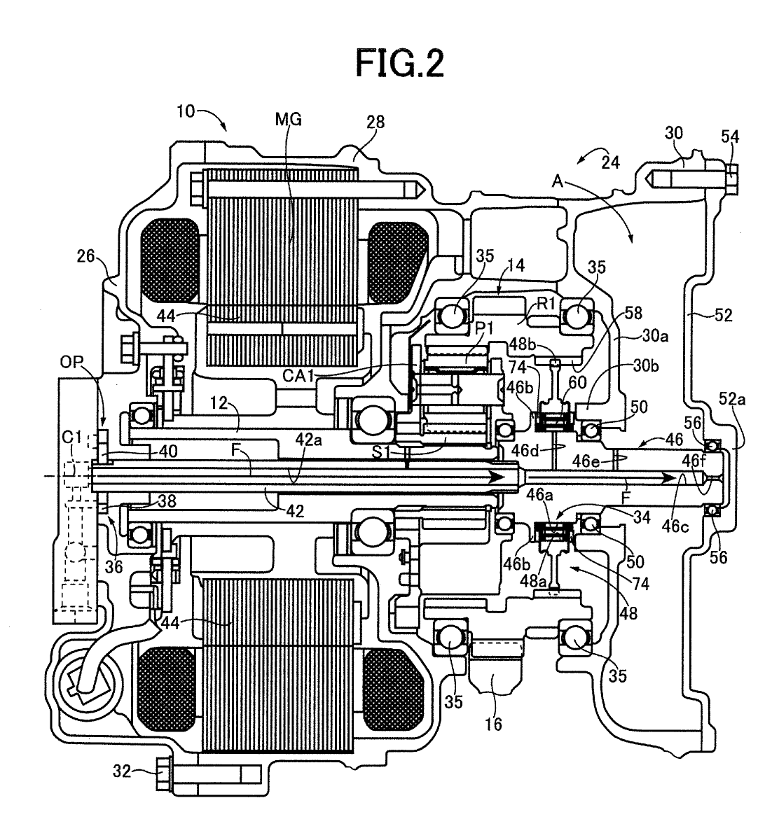

As depicted in FIGS. 1 and 2, the transaxle 10 houses an oil pump OP coupled via a one-way clutch 34 to the ring gear R1 of the planetary gear type speed reducer 14, which is the power transmission member transmitting power of the electric motor MG The ring gear R1 is rotatably supported by a pair of bearings 35 disposed on the transaxle case 28 and the transaxle housing 30 in the transaxle 10.

As depicted in FIG. 2, the oil pump OP is of an internal gear type in which an annular driven gear 38 is meshed with a drive gear 40 having outer circumferential teeth meshed with inner circumferential teeth of the driven gear 38 in a pump chamber 36 formed in the transaxle rear cover 26, and an oil pump shaft 42 is relatively non-rotatably coupled to the drive gear 40. The output shaft 12 of the electric motor MG is in a substantially cylindrical shape as depicted in FIGS. 1 to 3, and the oil pump shaft 42 penetrates through the inside of the output shaft 12. Therefore, the oil pump OP is located on a side of the electric motor MG opposite to the one-way clutch 34 in the transaxle 10 and is coupled to an inner race 46 described later via the oil pump shaft 42 disposed relatively rotatably through the output shaft 12, i.e., a rotor 44 of the electric motor MG.

As depicted in FIGS. 2 to 4, the one-way clutch 34 is interposed between an outer circumferential surface 46a of the shaft-shaped inner race 46 coupled via the oil pump shaft 42 to the oil pump OP and an inner circumferential surface 48a of an annular outer race 48 meshed with inner circumferential teeth 58 of the ring gear R1 of the planetary gear type speed reducer 14, and is held in a rotation axis C1 direction between a flange portion 46b radially projected such that an end portion of the outer circumferential surface 46a of the inner race 46 closer to the electric motor MG has a larger diameter, and a supporting portion (supporting member) 30b formed on a partition wall 30a of the transaxle housing 30 to rotatably support the inner race 46 via a first bearing 50. An end portion of the oil pump shaft 42 farther from the oil pump OP is relatively non-rotatably coupled by spline fitting to an end portion of the shaft-shaped inner race 46 closer to the oil pump OP. The supporting portion 30b of the transaxle housing 30 is projected in an annular shape from an inner circumferential portion of the partition wall 30a of the transaxle housing 30 in the rotation axis C1 direction toward the one-way clutch 34. To the transaxle housing 30, a cover 52 is fixed by a fixing member 54 such as a bolt at a predetermined distance from the partition wall 30a, and the inner race 46 is rotatably supported by a second bearing 56 disposed on a center portion 52a of the cover 52. Therefore, the inner race 46 is rotatably cantilevered around the rotation axis C1 by the first bearing 50 and the second bearing 56 in the transaxle 10.

As depicted in FIGS. 2 to 4, the outer race 48 has outer circumferential teeth 48b formed on an outer circumference thereof and engaged with the inner circumferential teeth 58 formed on an inner circumference of the ring gear R1 and is disposed rotatably along with the ring gear R1 around the same rotation axis C1 as the electric motor MG The inner race 46 is located on an inner circumferential side of the outer race 48 and coupled to the oil pump OP via the oil pump shaft 42, and is disposed rotatably along with the oil pump OP around the same rotation axis C1 as the electric motor MG The transaxle 10 is acquired by diverting a main configuration of a transaxle of a well-known two-motor type hybrid vehicle disposed with the planetary gear type speed reducer 14 acting as reduction planetary gears and a power dividing planetary gear on the inner circumferential side of a counter drive gear, i.e., the ring gear R1, and the inner race 46, the outer rave 48, and the one-way clutch 34 are arranged on the inner circumferential side of the ring gear R1 instead of the power dividing planetary gear. The inner circumferential teeth 58 of the ring gear R1 and the outer circumferential teeth 48b of the outer race 48 are helical gears having a tooth trace tilted relative to the rotation axis C1 of the one-way clutch 34.

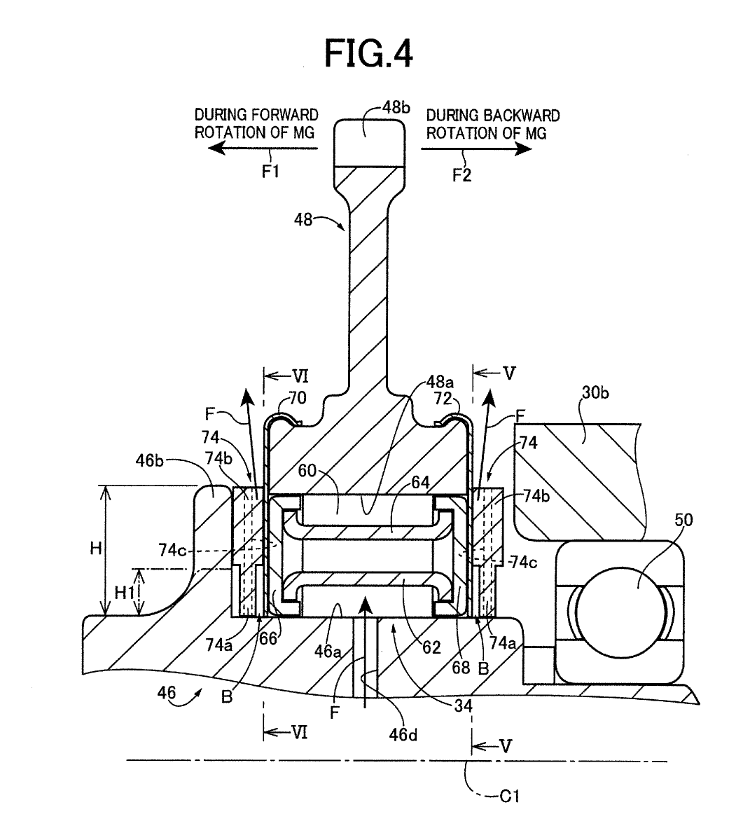

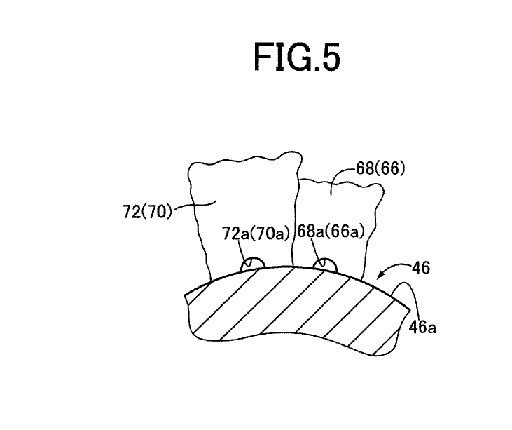

As depicted in FIG. 4, the one-way clutch 34 includes: a plurality of sprags 60 circumferentially arranged between the outer circumferential surface 46a of the inner race 46 and the inner circumferential surface 48a of the outer race 48; an inner circumferential side retainer 62 and an outer circumferential side retainer 64 retaining a constant distance 60 between the multiple sprags 60; a pair of end bearings 66 and 68 arranged on both sides of a plurality of the sprags 60 to retain the sprags 60 at concentric positions during relative rotation of the inner race 46 and the outer race 48; and a pair of end plates 70 and 72 fixed to both side surfaces of the outer race 48 to retain a pair of the end bearings 66 and 68, the inner circumferential side retainer 62, the outer circumferential side retainer 64, and a plurality of the sprags 60 between the outer circumferential surface 46a of the inner race 46 and the inner circumferential surface 48a of the outer race 48. As depicted in FIG. 5, a pair of the end plates 70 and 72 is provided with cutouts 70a, 72a cut out at a plurality of positions of inner circumferential portions of the annular end plates 70, 72, and a pair of the end bearings 66 and 68 is provided with cutouts 66a, 68a cut out at a plurality of positions of inner circumferential portions of the annular end bearings 66, 68. In the one-way clutch 34, the cutouts 66a, 68a of the end bearings 66, 68 and the cutouts 70a, 72a of the end plates 70, 72 act as through-passages allowing lubrication oil F to communicate between the inside, i.e., a space between the outer circumferential surface 46a of the inner race 46 and the inner circumferential surface 48a of the outer race 48, and the outside of the one-way clutch 34.

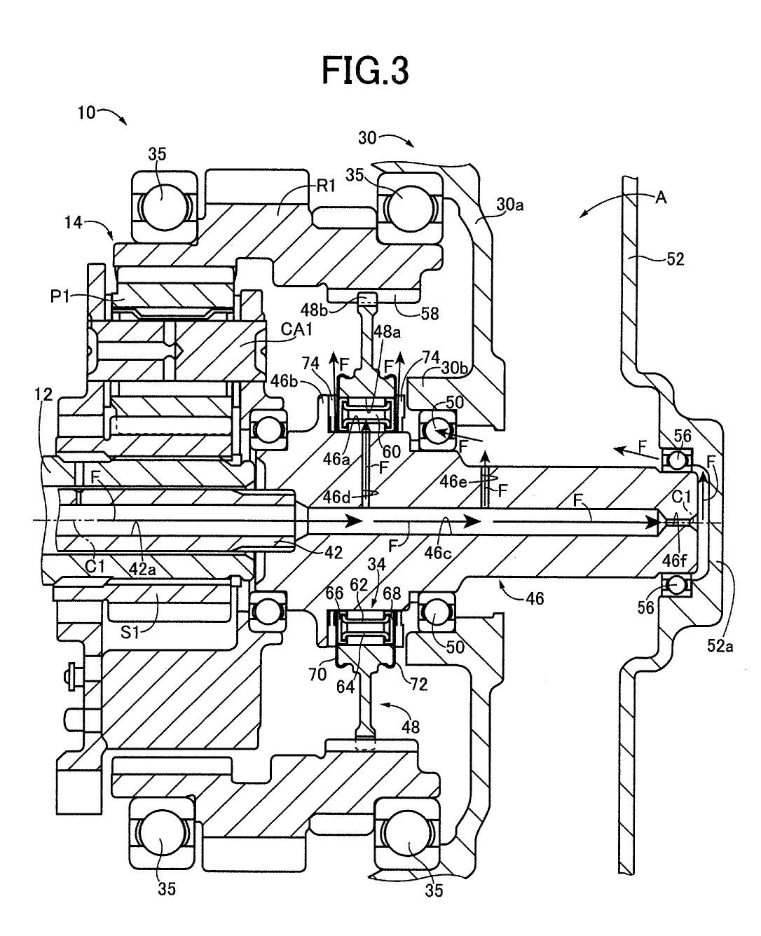

As depicted in FIGS. 2 and 3, the oil pump shaft 42 is provided with a first oil hole 42a penetrating along the shaft center of the oil pump shaft 42, and the inner race 46 is provided with a second oil hole 46c communicating with the first oil hole 42a of the oil pump shaft 42. The inner race 46 is drilled to make a first radial hole (oil hole) 46d radially formed to communicate with the second oil hole 46c in the outer circumferential surface 46a of the inner race 46 disposed with a plurality of the sprags 60, a second radial hole 46e radially formed to communicate with the second oil hole 46c in the outer circumferential surface 46a of the inner race 46 on the side closer to the cover 52 than the first radial hole 46d, and a third oil hole 46f formed in the shaft center direction to communicate with the second oil hole 46c in the inner race 46 on the side closer to the cover 52 than the second radial hole 46e. Therefore, when the electric motor MG rotates forward and the oil pump shaft 42 is rotated via the one-way clutch 34, the lubrication oil F is discharged from the oil pump OP to the first oil hole 42a of the oil pump shaft 42, and the lubrication oil F is forced to flow into the second oil hole 46c of the inner race 46.

Arrows depicted in FIGS. 2 to 4 indicate the flow of the lubrication oil F discharged from the oil pump OP.

When the lubrication oil F flows into the second oil hole 46c of the inner race 46, the lubrication oil F is supplied between the outer circumferential surface 46a of the inner race 46 and the inner circumferential surface 48a of the outer race 48 via the first radial hole 46d and is supplied via the second radial hole 46e to an oil chamber A formed between the transaxle housing 30 and the cover 52 and the first bearing 50. The lubrication oil F is supplied via the third oil hole 46f to the second bearing 56. A portion of the lubrication oil F flowing out from the second radial hole 46e and the third oil hole 46f of the inner race 46 can be accumulated in the oil chamber A and the lubrication oil F accumulated in the oil chamber A is supplied to gears and bearings, for example. Therefore, the oil chamber A acts as an oil catch tank.

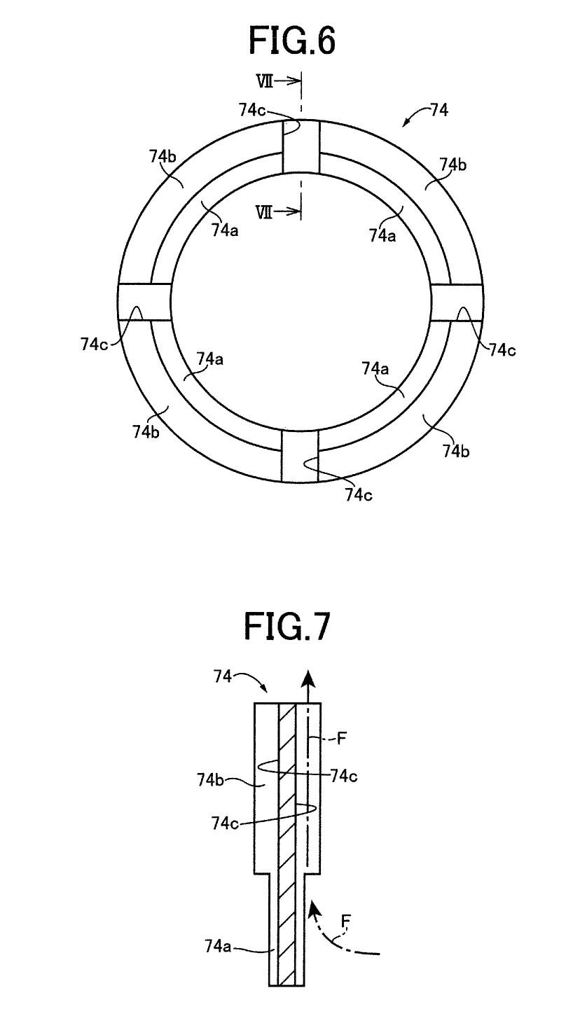

As depicted in FIGS. 4, 6, and 7, respective annular sliding washers 74 are disposed between the end plate 70 of the one-way clutch 34 and the flange portion 46b of the inner race 46 and between the end plate 72 of the one-way clutch 34 and the supporting portion 30b of the transaxle housing 30. Each of the annular sliding washers 74 is integrally made up of an annular thin portion 74a having a thickness thinner than an outer circumferential portion and an annular thick portion 74b having a thickness thicker than the thin portion 74a on an outer circumferential side of the annular thin portion 74a. Each of the both side surfaces of the sliding washer 74 is disposed with oil grooves 74c dented in the thickness direction and formed at four positions in each of the both side surfaces. For example, the sliding washers 74 are preferably made of a material used as sliding bearing material and hardly causing seizure, having high abrasion resistance, and having large compression strength, such as copper alloy, sintered alloy, cast iron, brass (Cu—Zn alloy), bronze (aluminum bronze, phosphor bronze), plastic, white metal (Pb, Sn, Sb), kelmet (Cu—Pb), cadmium alloy, aluminum alloy, and silver. As depicted in FIG. 4, the flange portion 46b of the inner race 46 is projected from the outer circumferential surface 46a of the inner race 46 to the same height as the height H of the sliding washer 74 in the radial direction of the inner race 46.

In the transaxle 10 configured as described above, when the electric motor MG rotates forward and the outer race 48, i.e., the one-way clutch 34, moves toward an arrow F1 in the rotation axis C1 direction as depicted in FIG. 4, the one-way clutch 34 comes into contact with the flange portion 46b of the inner race 46 via the sliding washer 74 and, therefore, direct contact is prevented between the one-way clutch 34 and the flange portion 46b of the inner race 46. For example, if the height of the flange portion 46b formed in the inner race 46 is H1 as indicated by a dashed-dotted line of FIG. 4, the movement of the outer race 48 in the arrow F1 direction brings the sliding washer 74 in a bent state into sliding contact with the flange portion 46b and the one-way clutch 34 and, therefore, uneven wear may occur in the sliding washer 74; however, since the flange portion 46b is projected from the outer circumferential surface 46a of the inner race 46 to the height equal to or greater than the height H of the sliding washer 74, the uneven wear of the sliding washer 74 as described above is prevented.

When the electric motor MG rotates backward and the outer race 48, i.e., the one-way clutch 34, moves toward an arrow F2 in the rotation axis C1 direction as depicted in FIG. 4, the one-way clutch 34 comes into contact with the supporting portion 30b of the transaxle housing 30 via the sliding washer 74 and, therefore, direct contact is prevented between the one-way clutch 34 and the supporting portion 30b while differential rotation occurs between the outer race 48 and the supporting portion 30b of the transaxle housing 30.

When the electric motor MG rotates forward and the oil pump shaft 42 is rotated via the one-way clutch 34, the lubrication oil F is discharged from the oil pump OP to the first oil hole 42a of the oil pump shaft 42 and is supplied between the inner circumferential surface 48a of the outer race 48 and the outer circumferential surface 46a of the inner race 46 via the second oil hole 46c and the first radial hole 46d of the inner race 46. The supplied lubrication oil F flows via the through-passages formed by the cutouts 66a, 68a of a pair of the end bearings 66 and 68 and the cutouts 70a, 72a of a pair of the end plates 70 and 72 into an annular space B between the thin portion 74a of the sliding washer 74 and the end plate 70, 72 and the oil grooves 74c as depicted in FIG. 7 and is supplied via the oil grooves 74c to components such as the one-way clutch 34, the ring gear R1, and the bearings 35, for example.

As described above, according to the transaxle 10 of this embodiment, when the electric motor MG is driven and the one-way clutch 34 moves in the rotation axis C1 direction of the one-way clutch 34, the one-way clutch 34 comes into contact with the flange portion 46b of the inner race 46 or the supporting portion 30b of the transaxle housing 30 via the sliding washer 74 and, therefore, direct contact is prevented between the one-way clutch 34 and the flange portion 46b of the inner race 46 or the supporting portion 30b and the wear, seizure, etc. of the one-way clutch 34 are suppressed.

According to the transaxle 10 of this embodiment, the power transmission member transmitting the power of the electric motor MG is the ring gear R1 of the planetary gear type speed reducer 14 disposed concentrically to the electric motor MG for reducing the rotation speed of the electric motor MG and the outer race 48 is engaged with the inner circumferential teeth 58 of the ring gear R1 and is disposed rotatably along with the ring gear R1 around the same rotation axis C1 as the electric motor MG, while the inner race 46 is located on the inner circumferential side of the outer race 48 and coupled to the oil pump OP and is disposed rotatably along with the oil pump OP around the same rotation axis C1 as the electric motor MG. Therefore, the rotation speed of the electric motor MG is reduced via the planetary gear type speed reducer 14 and transmitted to the one-way clutch 34. A main configuration of a transaxle of a conventional two-motor type hybrid vehicle can preferably be diverted to the transaxle 10.

According to the transaxle 10 of this embodiment, the oil pump OP is located on the side of the electric motor MG opposite to the one-way clutch 34 in the transaxle 10 and is coupled to the inner race 46 via the oil pump shaft 42 disposed relatively rotatably through the rotor 44 of the electric motor MG. Therefore, the ring gear R1 of the planetary gear type speed reducer 14 acting as the power transmission member and the oil pump OP can preferably be coupled via the one-way clutch 34.

According to the transaxle 10 of this embodiment, since the height of the flange portion 46b from the outer circumferential surface 46a of the inner race 46 is equal to or greater than the height H of the sliding washer 74, the uneven wear of the sliding washer 74 can be prevented.

Another embodiment of the present invention will then be described in detail with reference to the drawings. In the following description, the portions mutually common to the embodiments are denoted by the same reference numerals and will not be described.

### Second Embodiment

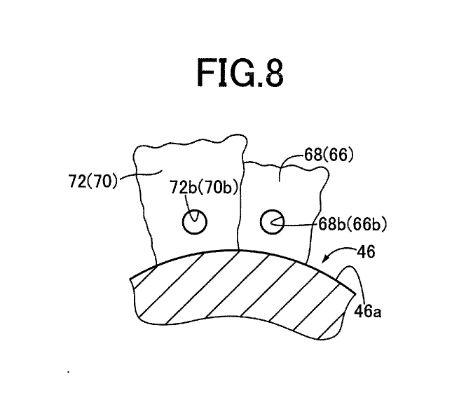

An electric vehicle transaxle of this embodiment is different from the transaxle 10 of the first embodiment in that through-holes 66b, 68b are formed instead of the cutouts 66a, 68a formed in a pair of the end bearings 66 and 68 and that through-holes 70b, 72b are formed instead of the cutouts 70a, 72a formed in a pair of the end plates 70 and 72 as depicted in FIG. 8, and the other points are substantially the same as the transaxle 10. The through-holes 66b, 68b of the end bearings 66, 68 and the through-holes 70b, 72b of the end plate 70, 72 act as through-passages allowing the lubrication oil F to communicate between the inside of the one-way clutch 34, i.e., the space between the outer circumferential surface 46a of the inner race 46 and the inner circumferential surface 48a of the outer race 48, and the outside of the one-way clutch 34, as is the case with the first embodiment described above.

Although the embodiments of the present invention have been described in detail with reference to the drawings, the present invention is applied in other forms.

For example, although the transaxle 10 of the embodiment includes the sliding washers 74 having the oil grooves 74c formed in the thin portion 74a and the thick portion 74b, the oil grooves 74c may be formed only in the thick portion 74b. In other words, the oil grooves 74c of the sliding washers 74 are not particularly limited in terms of shape etc., as long as the lubrication oil F flowing in between the outer circumferential surface 46a of the inner race 46 and the inner circumferential surface 48a of the outer race 48 is supplied via the oil grooves 74c to the components such as the one-way clutch 34, the ring gear R1, and the bearings 35.

Although not exemplarily illustrated one by one, the present invention can be implemented in variously modified and improved forms based on the knowledge of those skilled in the art.

### Nomenclature of Elements

10: transaxle (electric vehicle transaxle) 14: planetary gear type speed reducer

30b: supporting portion (supporting member) 34: one-way clutch 42: oil pump shaft 44: rotor 46: inner race 46a: outer circumferential surface 46b: flange portion 48: outer race 58: inner circumferential teeth 74: sliding washers 74c: oil grooves C1: rotation axis H: height MG: electric motor (driving electric motor) OP: oil pump R1: ring gear (power transmission member)

1. An electric vehicle transaxle comprising
a one-way clutch;
a drive electric motor
a power transmission member that transmits a power of the driving electric motor; and
an oil pump coupled to the power transmission member via the one-way clutch;
the one-way clutch being interposed between an inner race coupled to the oil pump and an outer race coupled to the power transmission member, the one-way clutch being held in a rotation axis direction between a flange portion disposed on an outer circumferential surface of the inner race and a supporting member rotatably supporting the inner race,
the electric vehicle transaxle being disposed with respective sliding washers having oil grooves between the one-way clutch and the flange portion and between the one-way clutch and the supporting member.

2. The electric vehicle transaxle of claim 1, wherein
the power transmission member is a ring gear of a planetary gear type speed reducer disposed concentrically to the driving electric motor for reducing rotation speed of the driving electric motor, wherein
the outer race is engaged with inner circumferential teeth of the ring gear and is disposed rotatably along with the ring gear around the same rotation axis as the driving electric motor, and wherein
the inner race is located on an inner circumferential side of the outer race and coupled to the oil pump and is disposed rotatably along with the oil pump around the same rotation axis as the driving electric motor.

3. The electric vehicle transaxle of claim 1, wherein the oil pump is located on a side of the driving electric motor opposite to the one-way clutch and is coupled to the inner race via an oil pump shaft disposed through a rotor of the driving electric motor so as to be rotatable relative to the rotor.

4. The electric vehicle transaxle of claim 2, wherein the oil pump is located on a side of the driving electric motor opposite to the one-way clutch and is coupled to the inner race via an oil pump shaft disposed through a rotor of the driving electric motor so as to be rotatable relative to the rotor.

5. The electric vehicle transaxle of claim 1, wherein a height of the flange portion from the outer circumferential surface of the inner race is equal to or greater than a height of the sliding washer.

6. The electric vehicle transaxle of claim 2, wherein a height of the flange portion from the outer circumferential surface of the inner race is equal to or greater than a height of the sliding washer.

7. The electric vehicle transaxle of claim 3, wherein a height of the flange portion from the outer circumferential surface of the inner race is equal to or greater than a height of the sliding washer.
